(19) United States
(12) Patent Application Publication
(10) Pub. No.: US 2025/0219086 A1
(43) Pub. Date: Jul. 3, 2025

(54) ENERGY STORAGE DEVICE AND ENERGY STORAGE APPARATUS

(71) Applicant: GS Yuasa International Ltd., Kyoto-shi, Kyoto (JP)

(72) Inventor: Daisuke ENDO, Kyoto (JP)

(21) Appl. No.: 18/686,694

(22) PCT Filed: Aug. 23, 2022
(86) PCT No.: PCT/JP2022/031696

§ 371 Date: Feb. 26, 2025

(30) Foreign Application Priority Data
Aug. 31, 2021 (JP) 2021-141887

(51) Int. Cl. H01M 4/62; H01M 4/02; H01M 4/136; H01M 4/58; H01M 10/0525; H01M 10/0567; H01M 10/0568; H01M 10/0569

(52) U.S. Cl. CPC H01M 4/625; H01M 4/136; H01M 4/5825; H01M 10/0525; H01M 10/0567; H01M 10/0568; H01M 10/0569; H01M 2004/021; H01M 2004/028

(57) ABSTRACT

An energy storage device according to one aspect of the present invention includes: a positive electrode including a positive active material layer containing a positive active material; and a nonaqueous electrolyte, in which the positive active material contains a polyanion compound containing a transition metal element and including a surface at least partially covered with carbon, a ratio of a second BET specific surface area, which is a BET specific surface area of the carbon, to a first BET specific surface area, which is a BET specific surface area of the positive active material layer is more than 10% and less than 35%, and the nonaqueous electrolyte contains an electrolyte salt containing no sulfur element and a sulfur-based compound.

### TECHNICAL FIELD

The present invention relates to an energy storage device and an energy storage apparatus.

### BACKGROUND ART

Nonaqueous electrolyte secondary batteries typified by lithium ion secondary batteries are often used for electronic devices such as personal computers and communication terminals, motor vehicles, and the like since, because the batteries are high in energy density. The nonaqueous electrolyte secondary batteries generally includes a pair of electrodes electrically isolated by a separator and a nonaqueous electrolyte interposed between the electrodes, and are configured to allow charge support ions to be transferred between the two electrodes for charge-discharge. In addition, capacitors such as lithium ion capacitors and electric double-layer capacitors are also widely in use as energy storage devices except for the nonaqueous electrolyte secondary batteries.

In recent years, a polyanion compound such as an olivine-type positive active material, which is inexpensive and highly safe, has attracted attention as a positive active material used in the energy storage device. For example, in an olivine type positive active material, since electron conductivity is low, it is difficult to obtain a discharge capacity close to the theoretical capacity, but a technique of coating a surface with carbon for improving the electron conductivity has been proposed (see Patent Document 1).

### PRIOR ART DOCUMENT

### Patent Document

Patent Document 1: JP-A-2008-034306

### SUMMARY OF THE INVENTION

### Problems to be Solved by the Invention

When the energy storage device is applied to a starting battery of an automobile or the like, initial power characteristics in a low temperature environment is required. Since the initial power characteristics in this low temperature environment are also affected by factors other than the electron conductivity of the positive active material, further improvement is required even when a polyanion compound whose surface is coated with carbon is used.

An object of the present invention is to provide an energy storage device and an energy storage apparatus which have high initial power in a low temperature environment.

### Means for Solving the Problems

An energy storage device according to one aspect of the present invention includes: a positive electrode including a positive active material layer containing a positive active material; and a nonaqueous electrolyte, in which the positive active material contains a polyanion compound containing a transition metal element and including a surface at least partially covered with carbon, a ratio of a second BET specific surface area, which is a BET specific surface area of the carbon, to a first BET specific surface area, which is a BET specific surface area of the positive active material layer is more than 10% and less than 35%, and the nonaqueous electrolyte contains an electrolyte salt containing no sulfur element and a sulfur-based compound.

An energy storage apparatus according to another aspect of the present invention includes two or more energy storage devices, and one or more energy storage devices according to the other aspect of the present invention.

### Advantages of the Invention

The energy storage device according to one aspect of the present invention has high initial power in a low temperature environment.

An energy storage apparatus according to another aspect of the present invention has high initial power in a low temperature environment.

### BRIEF DESCRIPTION OF THE DRAWINGS

FIG. 1 is a see-through perspective view illustrating an embodiment of an energy storage device.

FIG. 2 is a schematic diagram illustrating an embodiment of an energy storage apparatus including a plurality of the energy storage devices assembled.

### MODE FOR CARRYING OUT THE INVENTION

First, an outline of an energy storage device disclosed in the present specification will be described.

An energy storage device according to one aspect of the present invention includes: a positive electrode including a positive active material layer containing a positive active material; and a nonaqueous electrolyte, in which the positive active material contains a polyanion compound containing a transition metal element and including a surface at least partially covered with carbon, a ratio of a second BET specific surface area, which is a BET specific surface area of the carbon, to a first BET specific surface area, which is a BET specific surface area of the positive active material layer is more than 10% and less than 35%, and the nonaqueous electrolyte contains an electrolyte salt containing no sulfur element and a sulfur-based compound.

The energy storage device has high initial power in a low temperature environment. The reason for this is not necessarily clear, but is presumed as follows, for example. When the ratio of the second BET specific surface area to the first BET specific surface area is less than 35%, the coating amount of carbon is relatively reduced, and diffusion of charge support ions such as lithium ions is improved. On the other hand, when the ratio of the second BET specific surface area to the first BET specific surface area is more than 10%, the contact resistance between the positive active materials in the positive active material layer can be reduced. As described above, when the ratio of the second BET specific surface area to the first BET specific surface area satisfies the above range, the initial power of the energy storage device in a low temperature environment can be increased. In addition, since the nonaqueous electrolyte contains the sulfur-based compound, a film having a relatively low resistance is formed on the surface of the negative electrode of the energy storage device, so that the initial power of the energy storage device in a low temperature environment can be increased.

Therefore, it is presumed that the initial power of the energy storage device in a low temperature environment is high because the ratio of the second BET specific surface area to the first BET specific surface area satisfies the above range and the nonaqueous electrolyte contains the sulfur-based compound.

The “BET specific surface area” is determined by immersing a measurement sample in liquid nitrogen, and measuring the pressure and the nitrogen adsorption amount at the time, based on the fact that nitrogen molecules are physically adsorbed on the particle surface by supplying a nitrogen gas. The BET specific surface area is measured by the following method. The amount (m²) of nitrogen adsorption on the measurement sample is determined with the use of a specific surface area measurement apparatus (trade name: MONOSORB) manufactured by YUASA IONICS Co., Ltd. The value obtained by dividing the obtained adsorption amount by the mass (g) of the measurement sample is defined as the BET specific surface area (m²/g).

The first BET specific surface area is measured by the following method.

For the sample of the positive active material layer to be subjected to the measurement of the first BET specific surface area, when the positive electrode before the preparation of the energy storage device is available, the powder of the positive active material layer collected from the positive electrode is subjected to the measurement as it is. On the other hand, when a measurement sample is collected from the positive electrode taken out by disassembling the energy storage device, the sample of the positive active material layer to be subjected to the measurement of the first BET specific surface area is prepared by the following method. The energy storage device s subjected to constant current discharge at 0.05 C to a lower limit voltage in normal use. The energy storage device is disassembled, the positive electrode is taken out as a working electrode, and a half cell is assembled with metal Li as a counter electrode. Constant current discharge is performed at a current value of 10 mA per 1 g of the positive active material until the potential of the working electrode reaches 2.0 V vs. Li/Lit. The half cell is disassembled, and the working electrode is then taken out, and sufficiently washed with a dimethyl carbonate. After drying under reduced pressure at room temperature for 24 hours, a powder of the positive active material layer collected from the positive electrode is used as a measurement sample of the positive active material layer to be subjected to measurement of the first BET specific surface area.

Next, 1.00 g of the powder of the positive active material layer is put in a sample tube for measurement, and dried under reduced pressure at 120° C. for 12 hours to sufficiently remove moisture in the measurement sample. Next, after cooling with the use of liquid nitrogen and vacuum evacuation, an adsorption isotherm is measured by a nitrogen gas adsorption method within the range of a relative pressure P/P0 (P0=about 770 mmHg) from 0 to 1. Five points are extracted from the region of P/P0=0.05 to 0.3 of the obtained adsorption isotherm, BET plotting is performed, and the first BET specific surface area is calculated from the y intercept and slope of the straight line. The disassembly of the energy storage device to the collection of the powder of the positive active material layer are performed in an argon atmosphere having a dew point of −60° C. or lower.

The second BET specific surface area is measured by the following method.

A sample of the positive active material layer to be subjected to the measurement of the second BET specific surface area is prepared by the following method. First, for the powder of the positive active material layer collected in the same manner as the sample of the positive active material layer to be subjected to the measurement of the first BET specific surface area, optional components such as a conductive agent mixed with the powder of the positive active material layer are removed using wind power classification or the like. Then, the powder of the positive active material surface-coated with carbon is collected, and the BET specific surface area is determined by the above method. Next, the positive active material surface-coated with carbon is heat-treated at 400° C. for 2 hours in an air atmosphere to remove the surface-coated carbon, thereby the powder of the positive active material is obtained. Next, the powder of the obtained positive active material is collected, and the BET specific surface area is determined by the above method. Furthermore, the second BET specific surface area, which is the BET specific surface area of carbon, is calculated by determining the difference between the BET specific surface area of the positive active material surface-coated with carbon and the BET specific surface area of the positive active material.

Then, the ratio (%) of the calculated second BET specific surface area to the calculated first BET specific surface area is calculated.

The energy storage device includes an energy storage device in which the positive active material layer does not substantially contain a conductive agent. When the positive active material layer does not contain a conductive agent, the power retention rate of the energy storage device after high-temperature storage is increased. The reason for this is not necessarily clear, but is presumed as follows, for example. Usually, since the particle size of the conductive agent is smaller than the particle size of the carbon-coated polyanion compound, the BET specific surface area of the entire positive active material layer (first BET specific surface area) increases as the content of the conductive agent increases. When the BET specific surface area of the entire positive active material layer increases, the contact area (reaction area) between the nonaqueous electrolyte and the polyanion compound increases, and the transition metal element in the polyanion compound may be eluted into the nonaqueous electrolyte. As described above, when the transition metal element is eluted into the nonaqueous electrolyte, resistance is likely to increase after storage in a high temperature environment. However, when the positive active material layer does not substantially contain the conductive agent, the BET specific surface area of the entire positive active material layer decreases, and the contact area (reaction area) between the nonaqueous electrolyte and the polyanion compound decreases. As a result, the increase in resistance after storage in a high temperature environment decreases. Accordingly, it is presumed that the power retention rate of the energy storage device after the storage at a high temperature is increased.

An energy storage apparatus according to another aspect of the present invention includes two or more energy storage devices, and one or more energy storage devices according to the other aspect of the present invention.

Since the energy storage apparatus includes the energy storage device having a high initial power in a low temperature environment, the initial power in the low temperature environment is increased.

The configuration of an energy storage device, the configuration of an energy storage apparatus, a method for manufacturing the energy storage device according to an embodiment of the present invention, and other embodiments will be described in detail. It is to be noted that the names of the respective constituent members (respective constituent elements) for use in the respective embodiments may be different from the names of the respective constituent members (respective elements) for use in the background art.

### <Configuration of Energy Storage Device>

### [Positive Electrode]

The positive electrode includes a positive substrate and a positive active material layer disposed directly on the positive substrate or over the positive substrate with an intermediate layer interposed therebetween. The positive active material layer includes a positive active material. The positive active material contains a polyanion compound containing a transition metal element and including a surface at least partially covered with carbon.

### (Positive Substrate)

The positive substrate has conductivity. Whether the positive substrate has “conductivity” or not is determined with the volume resistivity of 10⁷ Ω·cm measured in accordance with JIS-H-0505 (1975) as a threshold. As the material of the positive substrate, a metal such as aluminum, titanium, tantalum, or stainless steel, or an alloy thereof is used. Among these metals and alloys, aluminum or an aluminum alloy is preferable from the viewpoints of electric potential resistance, high conductivity, and cost. Examples of the positive substrate include a foil, a deposited film, a mesh, and a porous material, and a foil is preferable from the viewpoint of cost. Accordingly, the positive substrate is preferably an aluminum foil or an aluminum alloy foil. Examples of the aluminum or aluminum alloy include A1085, A3003, A1N30, and the like specified in JIS-H-4000 (2014) or JIS-H-4160 (2006).

The average thickness of the positive substrate is preferably 3 μm or more and 50 μm or less, more preferably 5 μm or more and 40 μm or less, still more preferably 8 μm or more and 30 μm or less, particularly preferably 10 μm or more and 25 μm or less. The average thickness of the positive substrate falls within the range mentioned above, thereby making it possible to increase the energy density per volume of the energy storage device while increasing the strength of the positive substrate.

The intermediate layer is a layer arranged between the positive substrate and the positive active material layer. The intermediate layer includes a conductive agent such as carbon particles to reduce contact resistance between the positive substrate and the positive active material layer. The configuration of the intermediate layer is not particularly limited, and includes, for example, a binder and a conductive agent.

### (Positive Active Material Layer)

The positive active material layer includes a positive active material. The positive active material layer contains optional components such as a binder (binding agent), a thickener, and a filler as necessary. On the other hand, the positive active material layer may or may not substantially contain a conductive agent. The positive active material contains a polyanion compound containing a transition metal element and including a surface at least partially covered with carbon.

The polyanion compound can occlude and release ions. The polyanion compound is a compound containing an oxoacid anion (PO₄³⁻, SO₄²⁻, SiO₄⁴⁻—, BO₃³⁻, VO₄³⁻, etc.), a transition metal element, and an alkali metal element or an alkaline earth metal element. The oxoacid anion may be a condensed anion (P₂O₇⁴⁻, P₃O₁₀⁵⁻, etc.). The polyanion compound may further contain other elements (for example, halogen elements). The oxoacid anion of the polyanion compound is preferably a phosphate anion (PO₄³⁻). As the transition metal element of the polyanion compound, an iron element, a manganese element, a nickel element, and a cobalt element are preferable, and an iron element is more preferable. The alkali metal element or alkaline earth metal element of the polyanionic compound is preferably a lithium element.

The polyanion compound is preferably a compound represented by the following Formula 1.

LiₐM_{b}(AO_{c})_{d}Xₑ 1

In Formula 1, M represents at least one transition metal element. A is at least one selected from B, Al, Si, P, S, CI, Ti, V, Cr, Mo, and W. X is at least one halogen element. a, b, c, d, and e are numbers that satisfy 0<a≤3, 0<b≤2, 2≤c≤4, 1≤d≤3, and 0≤e≤1. Each of a, b, c, d, and e may be an integer or a decimal.

M in Formula 1 preferably contains at least one of Fe, Mn, Ni, and Co, and the total content of Fe, Mn, Ni, and Co in M is more preferably 50 mol % or more, the content of at least one of Fe, Mn, Ni, and Co in M is still more preferably 50 mol % or more, and the content of Fe in M is still more preferably 50 mol % or more. M is also preferably at least one of Fe, Mn, Ni, and Co, and is also preferably Fe. A is preferably P. X is preferably F. As an embodiment, a=1, b=1, c=4, d=1, and e=0 may be preferable.

Specific examples of the polyanion compound include LiFePO₄, LiCoPO₄, LiFe_{0.5}Co_{0.5}PO₄, LiMnPO₄, LiNiPO₄, LiMn_{0.5}Fe_{0.5}PO₄, LiCrPO₄, LiFeVO₄, Li₂FeSiO₄, Li₂Fe₂(SO₄)₃, LiFeBO₃, LiFePO_{3.9}F_{0.2}, Li₃V₂(PO₄)₃, Li₂MnSiO₄, and Li₂CoPO₄F. Among them, LiFePO₄ (lithium iron phosphate) is preferable. Some of atoms or polyanions in the polyanion compounds exemplified above may be partially substituted with other atoms or anion species. One of the polyanion compound may be used singly, or two or more thereof may be used in mixture.

At least a part of the surface of the polyanion compound is coated with carbon. Carbon refers to carbon as an inorganic substance. Since at least a part of the surface of the polyanion compound is coated with carbon, the electron conductivity is improved.

The polyanion compound is a particle (powder). The average particle size of the polyanion compound is preferably 0.1 μm or more and 20 μm or less, for example. By setting the average particle size of the polyanion compound to be equal to or more than the above lower limit, the polyanion compound is easily produced or handled. By setting the average particle size of the polyanion compound to be equal to or less than the above upper limit, ion diffusibility in the positive active material layer is improved. When a composite of a polyanion compound and another material such as carbon is used, the average particle size of the composite is regarded as the average particle size of the positive active material. The “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013). Hereinafter, the “average particle size” is synonymous.

A crusher, a classifier and the like are used to obtain a powder having a predetermined particle size. Examples of the crushing method include a method of using a mortar, a ball mill, a sand mill, a vibratory ball mill, a planetary ball mill, a jet mill, a counter jet mill, a whirling airflow-type jet mill, a sieve, or the like. At the time of crushing, wet-type crushing in coexistence of water or an organic solvent such as hexane can also be used. As a classification method, a sieve, a pneumatic classifier and the like are used both in dry manner and in wet manner if necessary.

The polyanion compound can be produced, for example, based on the following procedure. That is, first, an aqueous solution of one or more oxoacid anion salts of the transition metal element is mixed with an aqueous solution of sodium hydroxide (NaOH) in the presence of a buffer to prepare a precursor which is a hydroxide of the transition metal element. Next, the prepared precursor is solid-phase mixed with a carbon raw material such as an oxoacid anion salt of lithium and sucrose. Then, the obtained mixture is fired under an inert atmosphere, thereby making it possible to prepare a polyanion compound whose surface is at least partially covered with carbon. In addition, the coating amount of carbon can be increased or decreased by increasing or decreasing the addition amount of a carbon raw material such as sucrose.

For example, when the polyanion compound is lithium iron phosphate (LiFePO₄), first, while an aqueous solution of FeSO₄ is added dropwise to the reaction case at a constant rate, an aqueous NaOH solution, an aqueous NH₃ solution, and an aqueous NH₂NH₂ solution are added dropwise so that the pH during that time is maintained at a constant value, thereby preparing an Fe(OH)₂ precursor. Next, the prepared Fe(OH)₂ precursor is taken out from the reaction case, and solid-phase mixed with LiH₂PO₄ and sucrose powder. Then, the resulting mixture is fired at a firing temperature of 550° C. or higher and 750° C. or lower in a nitrogen atmosphere, whereby a polyanion compound in which LiFePO₄ particles as a polyanion compound are coated with carbon can be prepared.

The content of the polyanion compound in the positive active material layer is preferably 50% by mass or more and 99% by mass or less, more preferably 70% by mass or more and 98% by mass or less, and still more preferably 80% by mass or more and 95% by mass or less. When the content of the polyanion compound is in the above range, it is possible to achieve both high energy density and productivity of the positive active material layer.

The positive active material may further contain a positive active material (hereinafter, also referred to as “another positive active material”) other than the polyanion compound. Such another positive active material can be appropriately selected from known positive active materials for a lithium ion secondary battery. However, the lower limit of the total content of the carbon-coated polyanion compound in the positive active material is preferably 90% by mass, and more preferably 99% by mass. The upper limit of the total content of the carbon-coated polyanion compound in the positive active material may be 100% by mass. As described above, by substantially using only the polyanion compound as the positive active material, it is possible to more reliably increase the initial power of the energy storage device in a low temperature environment.

As the known positive active material for a lithium ion secondary battery, a material capable of storing and releasing lithium ions is usually used. Examples of other positive active material include lithium-transition metal composite oxides that have an α-NaFeO₂-type crystal structure, lithium-transition metal composite oxides that have a spinel-type crystal structure, chalcogenides, and sulfur. Examples of the lithium-transition metal composite oxides that have an α-NaFeO₂-type crystal structure include Li[LiₓNi₍₁₋ₓ₎]O₂ (0≤x<0.5), Li[LiₓNi_{y}Co_{(1-x-y)}]O₂ (0≤x<0.5, 0<y<1), Li[LiₓCo₍₁₋ₓ₎]O₂ (0≤x<0.5), Li[LiₓNi_{y}Mn_{(1-x-y)}]O₂ (0≤x<0.5, 0<y<1), Li[LiₓNi_{y}Mn_{ß}Co_{(1-x-y-ß)}]O₂ (0≤x<0.5, 0<y, 0<ß, 0.5<y+ß<1), and Li[LiₓNi_{y}Co_{ß}Al_{(1-x-y-ß)}]O₂ (0≤x<0.5, 0<y, 0<ß, 0.5<y+ß<1). Examples of the lithium-transition metal composite oxides that have a spinel-type crystal structure include LiₓMn₂O₄ and LiₓNi_{y}Mn_{(2-y)}O₄. Examples of the chalcogenides include a titanium disulfide, a molybdenum disulfide, and a molybdenum dioxide. Some of the atoms in these materials may be substituted with atoms composed of other elements. The surfaces of these materials may be coated with other materials. In the positive active material layer, one of these materials may be used singly, or two or more thereof may be used in mixture.

Examples of the binder include: thermoplastic resins such as fluororesin (polytetrafluoroethylene (PTFE), polyvinylidene fluoride (PVDF), etc.), polyethylene, polypropylene, polyacryl, and polyimide; elastomers such as ethylene-propylene-diene rubber (EPDM), sulfonated EPDM, styrene-butadiene rubber (SBR), and fluororubber; and polysaccharide polymers.

The content of the binder in the positive active material layer is preferably 1% by mass or more and 10% by mass or less, more preferably 3% by mass or more and 9% by mass or less. By setting the content of the binder in the above range, the active material can be stably held.

Examples of the thickener include polysaccharide polymers such as carboxymethylcellulose (CMC), and methylcellulose. When the thickener has a functional group that is reactive with lithium and the like, the functional group may be deactivated by methylation or the like in advance.

The filler is not particularly limited. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof.

The energy storage device includes an energy storage device in which the positive active material layer does not substantially contain a conductive agent. The conductive agent does not contain carbon covering at least a part of the surface of the polyanion compound. “The positive active material layer does not substantially contain a conductive agent” means that the content of the conductive agent in the positive active material layer, which adversely affects the improvement of the initial power in a low temperature environment, which is a problem of the present embodiment, is substantially 0% by mass, but it is not excluded that a trace amount of the conductive agent is contained in the positive active material layer within a range not inhibiting the improvement of the initial power in a low temperature environment. Specifically, “the positive active material layer does not substantially contain a conductive agent” means that the upper limit of the content of the conductive agent in the positive active material layer is 2% by mass, more preferably 1% by mass, still more preferably 0.5% by mass, and particularly preferably 0% by mass.

When the positive active material layer contains a conductive agent, the conductive agent is not particularly limited as long as it is a material having conductivity. Examples of such a conductive agent include carbonaceous materials, metals, and conductive ceramics. Examples of the carbonaceous materials include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the form of the conductive agent include a powdery form and a fibrous form. As the conductive agent, one of these materials may be used alone, or two or more thereof may be used in mixture. In addition, these materials may be used in combination. For example, a composite material of carbon black and CNT may be used. Among these materials, carbon black is preferable from the viewpoints of electron conductivity and coatability, and in particular, acetylene black is preferable.

The positive active material layer may contain a typical nonmetal element such as B, N, P, F, Cl, Br, or I, a typical metal element such as Li, Na, Mg, Al, K, Ca, Zn, Ga, Ge, Sn, Sr, or Ba, and a transition metal element such as Sc, Ti, V, Cr, Mn, Fe, Co, Ni, Cu, Mo, Zr, Nb, or W as a component other than the positive active material, the conductive agent, the binder, the thickener, and the filler.

The ratio of the second BET specific surface area to the first BET specific surface area is more than 10% and less than 35%, preferably 11% or more and 34% or less, more preferably 12% or more and 33% or less, still more preferably 13% or more and 32% or less, and still more preferably 14% or more and 31% or less. When the ratio of the second BET specific surface area to the first BET specific surface area satisfies the above range, the initial power of the energy storage device in a low temperature environment is increased.

The ratio of the second BET specific surface area to the first BET specific surface area can be adjusted by increasing or decreasing the coating amount of carbon with respect to the polyanion compound. Specifically, when a polyanion compound in which at least a part of the surface is coated with carbon is prepared, the addition amount of a carbon raw material such as sucrose to be solid-phase mixed, the firing temperature of the obtained mixture, and the like can be adjusted.

The first BET specific surface area of the positive active material layer is preferably 2.0 m²/g or more and 10.0 m²/g or less, and more preferably 0.5 m²/g or more and 8.0 m²/g or less. When the first BET specific surface area satisfies the above range, there is an advantage that both power characteristics and life characteristics can be achieved.

### [Negative Electrode]

The negative electrode has a negative substrate and a negative active material layer disposed directly on the negative substrate or over the negative substrate with an intermediate layer interposed therebetween. The configuration of the intermediate layer is not particularly limited, and for example, can be selected from the configurations exemplified for the positive electrode.

### (Negative Substrate)

The negative substrate exhibits conductivity. As the material of the negative substrate, a metal such as copper, nickel, stainless steel, nickel-plated steel, or aluminum, an alloy thereof, a carbonaceous material, or the like is used. Among these metals and alloys, the copper or copper alloy is preferable. Examples of the negative substrate include a foil, a deposited film, a mesh, and a porous material, and a foil is preferable from the viewpoint of cost. Accordingly, the negative substrate is preferably a copper foil or a copper alloy foil. Examples of the copper foil include a rolled copper foil and an electrolytic copper foil.

The average thickness of the negative substrate is preferably 2 μm or more and 35 μm or less, more preferably 3 μm or more and 30 μm or less, still more preferably 4 μm or more and 25 μm or less, and particularly preferably 5 μm or more and 20 μm or less. When the average thickness of the negative substrate falls within the range mentioned above, the energy density per volume of the energy storage device can be increased while increasing the strength of the negative substrate.

### (Negative Active Material Layer)

The negative active material layer includes a negative active material. The negative active material layer contains optional components such as a conductive agent, a binder, a thickener, and a filler, if necessary. The optional components such as a conductive agent, a binder, a thickener, and a filler can be selected from the materials exemplified for the positive electrode.

The negative active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Ta, Hf, Nb, and W as a component other than the negative active material, the conductive agent, the binder, the thickener, and the filler.

The negative active material can be appropriately selected from known negative active materials. As the negative active material for a lithium ion secondary battery, a material capable of absorbing and releasing lithium ions is usually used. Examples of the negative active material include metal Li; metals or metalloids such as Si and Sn; metal oxides or metalloid oxides such as oxides of Si, oxides of Ti, and oxides of Sn; titanium-containing oxides such as Li₄Ti₅O₁₂, LiTiO₂, and TiNb₂O₇; polyphosphoric acid compounds; silicon carbides; and carbon materials such as graphite and non-graphitic carbon (easily graphitizable carbon or hardly graphitizable carbon). Among these materials, the graphite and the non-graphitic carbon are preferable. In the negative active material layer, one of these materials may be used alone, or two or more thereof may be used in mixture.

The term “graphite” refers to a carbon material in which the average grid spacing (d₀₀₂) of the (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon material in which the average grid spacing (d₀₀₂) of the (002) plane determined by an X-ray diffraction method before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

In this regard, the “discharged state” means a state discharged such that lithium ions that can be occluded and released in association with charge-discharge are sufficiently released from the carbon material as the negative active material. For example, the “discharged state” refers to a state where the open circuit voltage is 0.7 V or higher in the half cell that has, for use as a working electrode, a negative electrode containing a carbon material as a negative active material, and has metal Li for use as a counter electrode.

The “hardly graphitizable carbon” refers to a carbon material in which the door is 0.36 nm or more and 0.42 nm or less.

The “easily graphitizable carbon” refers to a carbon material in which the d₀₀₂ is 0.34 nm or more and less than 0.36 nm.

The negative active material is typically particles (powder). The average particle size of the negative active material can be, for example, 1 nm or more and 100 μm or less. When the negative active material is a carbon material, a titanium containing oxide, or a polyphosphoric acid compound, the average particle size thereof may be 1 μm or more and 100 μm or less. When the negative active material is Si, Sn, an oxide of Si, an oxide of Sn, or the like, the average particle size thereof may be 1 nm or more and 1 μm or less. By setting the average particle size of the negative active material to be equal to or more than the lower limit mentioned above, the negative active material is easily produced or handled. By setting the average particle size of the negative active material to be equal to or less than the upper limit mentioned above, the electron conductivity of the active material layer is improved. A crusher, a classifier and the like are used to obtain a powder having a predetermined particle size. The crushing method and classification method can be selected from, for example, the methods exemplified for the positive electrode. When the negative active material is a metal such as metal Li, the negative active material may have the form of a foil.

The content of the negative active material in the negative active material layer is preferably 60% by mass or more and 99% by mass or less, more preferably 90% by mass or more and 98% by mass or less. The content of the negative active material falls within the range mentioned above, thereby allowing a balance to be achieved between the increased energy density and productivity of the negative active material layer.

### [Separator]

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining properties of the nonaqueous electrolyte. As the material for the substrate layer of the separator, for example, a polyolefin such as polyethylene or polypropylene is preferable from the viewpoint of shutdown function, and polyimide, aramid or the like is preferable from the viewpoint of resistance to oxidative decomposition. As the substrate layer of the separator, a material obtained by combining these resins may be used.

The heat resistant particles included in the heat resistant layer preferably have a mass loss of 5% or less in the case of temperature increase from room temperature to 500° C. under the air atmosphere of 1 atm, and more preferably have a mass loss of 5% or less in the case of temperature increase from room temperature to 800° C. Examples of materials that have a mass loss equal to or less than a predetermined value include inorganic compounds. Examples of the inorganic compound include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, boehmite, zeolite, apatite, kaolin, mullite, spinel, olivine, sericite, bentonite, and mica, and artificial products thereof. As the inorganic compounds, simple substances or complexes of these substances may be used alone, or two or more thereof may be used in mixture. Among these inorganic compounds, the silicon oxide, aluminum oxide, or aluminosilicate is preferable from the viewpoint of the safety of the energy storage device.

The porosity of the separator is preferably 80% by volume or less from the viewpoint of strength, and is preferably 20% by volume or more from the viewpoint of discharge performance. The term “porosity” herein is a volume-based value, and means a value measured with a mercury porosimeter.

As the separator, a polymer gel composed of a polymer and a nonaqueous electrolyte may be used. Examples of the polymer include a polyacrylonitrile, a polyethylene oxide, a polypropylene oxide, a polymethyl methacrylate, a polyvinyl acetate, a polyvinylpyrrolidone, and a polyvinylidene fluoride. The use of the polymer gel has the effect of suppressing liquid leakage. As the separator, the polymer gel may be used in combination with a porous resin film, a nonwoven fabric, or the like as described above.

### [Nonaqueous Electrolyte]

The nonaqueous electrolyte contains an electrolyte salt containing no sulfur element and a sulfur-based compound. For the nonaqueous electrolyte, a nonaqueous electrolyte solution may be used. The nonaqueous electrolyte solution contains a nonaqueous solvent, an electrolyte salt not containing the sulfur element dissolved in the nonaqueous solvent, and the sulfur-based compound. The sulfur-based compound corresponds to an additive other than the nonaqueous solvent and the electrolyte salt. The nonaqueous electrolyte solution may contain other additives in addition to the nonaqueous solvent, the electrolyte salt containing no sulfur element, and the sulfur-based compound.

The nonaqueous solvent can be appropriately selected from known nonaqueous solvents. Examples of the nonaqueous solvent include cyclic carbonates, chain carbonates, carboxylic acid esters, phosphoric acid esters, ethers, amides, and nitriles. As the nonaqueous solvent, solvents in which some of the hydrogen atoms included in these compounds are substituted with halogen may be used.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among them, EC is preferable.

Examples of the chain carbonate include diethyl carbonate (DEC), dimethyl carbonate (DMC), ethyl methyl carbonate (EMC), diphenyl carbonate, trifluoroethyl methyl carbonate, and bis(trifluoroethyl) carbonate. Among them, EMC is preferable.

As the nonaqueous solvent, it is preferable to use the cyclic carbonate or the chain carbonate, and it is more preferable to use the cyclic carbonate and the chain carbonate in combination. The use of the cyclic carbonate allows the promoted dissociation of the electrolyte salt to improve the ionic conductivity of the nonaqueous electrolyte solution. The use of the chain carbonate allows the viscosity of the nonaqueous electrolyte solution to be kept low. When the cyclic carbonate and the chain carbonate are used in combination, a volume ratio of the cyclic carbonate to the chain carbonate (cyclic carbonate: chain carbonate) is preferably in a range from 5:95 to 50:50, for example.

The nonaqueous electrolyte of the energy storage device contains a sulfur-based compound as an additive. The sulfur-based compound is not contained in the electrolyte salt. Since the nonaqueous electrolyte contains the sulfur-based compound, a film having a relatively low resistance is formed on the surface of the negative electrode of the energy storage device, so that the initial power of the energy storage device in a low temperature environment can be increased.

Examples of the sulfur-based compound include a chain compound containing a sulfur element (sulfur-based chain compound) and a cyclic compound containing a sulfur element (sulfur-based cyclic compound). Examples of the sulfur-based chain compound include imide salts such as lithium bis(fluorosulfonyl) imide (LiFSI), lithium bis(trifluoromethanesulfonyl)imide (LiTFSI), and lithium bis(pentafluoroethanesulfonyl) imide (LiBETI), dimethyl sulfite, methyl methanesulfonate, busulfan, methyl toluenesulfonate, dimethyl sulfate, diethyl sulfate, dipropyl sulfate, dibutyl sulfate, dimethylsulfone, diethylsulfone, dimethylsulfoxide, and diethylsulfoxide.

Examples of the sulfur-based cyclic compound include ethylene sulfite, propylene sulfite, sulfolane, thioanisole, tetramethylene sulfoxide, diphenyl sulfide, diphenyl disulfide, dipyridinium disulfide, a compound having a sultone structure, a compound having a cyclic sulfate structure, and the like. Examples of the compound having a sultone structure include propane sultone, propene sultone, butane sultone, and butene sultone. Examples of the compound having a cyclic sulfate structure include 4,4′-bis(2,2-dioxo-1,3,2-dioxathiolane), 4-methylsulfonylethyl-2,2-dioxo-1,3,2-dioxathiolane, ethylene sulfate, 4-fluoro-2,2-dioxo-1,3,2-dioxathiolane, 4,5-difluoro-2,2-dioxo-1,3,2-dioxathiolane, a propylene glycol sulfate, a butylene glycol sulfate, a pentene glycol sulfate, 4-5, dimethyl-dioxo-1,3,2-dioxathiolane, 4-fluorosulfonyloxymethyl-2,2-dioxo-1,3,2-dioxathiolane, 4-methylsulfonyloxymethyl-2,2-dioxo-1,3,2-dioxathiolane, 4-ethylsulfonyloxymethyl-2,2-dioxo-1,3,2-dioxathiolane, 4-trifluoromethylsulfonyloxymethyl-2,2-dioxo-1,3,2-dioxathiolane, 4-methylsulfonyloxymethyl-5-fluoro-2,2-dioxo-1,3,2-dioxathiolane, 4-methylsulfonyloxymethyl-5-methyl-2,2-dioxo-1,3,2-dioxathiolane, 4,4′-bis(5-fluoro-2,2-dioxo-1,3,2-dioxathiolane), 4,4′-bis(5-methyl-2,2-dioxo-1,3,2-dioxathiolane), and 4,4′-bis(5-ethyl-2,2-dioxo-1,3,2-dioxathiolane). Among them, sulfur-based cyclic compounds are preferable, and compounds having a sultone structure and compounds having a cyclic sulfate structure are more preferable. These sulfur-based compounds may be used singly or two or more thereof may be used in mixture.

The lower limit of the content of the sulfur-based compound in the nonaqueous electrolyte is preferably 0.1% by mass, more preferably 0.2% by mass, and still more preferably 0.3% by mass. In contrast, the upper limit of the content is preferably 9% by mass, more preferably 8% by mass or less, and still more preferably 5% by mass. By setting the content of the sulfur-based compound to the above lower limit or more and the above upper limit or less, it is possible to more reliably increase the initial power of the energy storage device in a low temperature environment.

The nonaqueous electrolyte may contain an additive other than the sulfur-based compound (hereinafter, also referred to as “other additives”). However, the lower limit of the total content of the sulfur-based compound in all the additives contained in the nonaqueous electrolyte is preferably 50% by mass, and more preferably 70% by mass. The upper limit of the total content of the sulfur-based compound in all the additives may be 100% by mass. As described above, by using substantially only the sulfur-based compound as the additive, it is possible to more reliably increase the initial power of the energy storage device in a low temperature environment.

Examples of the other additives include halogenated carbonate esters such as fluoroethylene carbonate (FEC) and difluoroethylene carbonate (DFEC); oxalates such as lithium bis(oxalate)borate (LiBOB), lithium difluorooxalateborate (LiFOB), lithium bis(oxalate) difluorophosphate (LiFOP); aromatic compounds such as biphenyl, alkylbiphenyl, terphenyl, partially hydrogenated products of terphenyl, cyclohexylbenzene, t-butylbenzene, t-amylbenzene, diphenyl ether, dibenzofuran; partial halides of the above aromatic compounds such as 2-fluorobiphenyl, o-cyclohexylfluorobenzene, p-cyclohexylfluorobenzene; halogenated anisole compounds such as 2,4-difluoroanisole, 2,5-difluoroanisole, 2,6-difluoroanisole, 3,5-difluoroanisole; vinylene carbonate, methyl vinylene carbonate, ethyl vinylene carbonate, succinic anhydride, glutaric anhydride, maleic anhydride, citraconic anhydride, glutaconic anhydride, itaconic anhydride, cyclohexanedicarboxylic anhydride; perfluorooctane, tristrimethylsilyl borate, tristrimethylsilyl phosphate, tetrakistrimethylsilyl titanate, lithium monofluorophosphate, and lithium difluorophosphate. One of these additives may be used alone, or two or more thereof may be used in mixture.

The electrolyte salt containing no sulfur element can be appropriately selected from known electrolyte salts. Examples of the electrolyte salt include a lithium salt, a sodium salt, a potassium salt, a magnesium salt, and an onium salt. Among these, a lithium salt is preferable.

Examples of the lithium salt include inorganic lithium salts such as LiPF₆, LiPO₂F₂, LiBF₄, and LiClO₄, and lithium oxalates such as lithium bis(oxalate) borate (LiBOB), lithium difluorooxalatoborate (LiFOB), and lithium bis(oxalate) difluorophosphate (LiFOP). Among these salts, the inorganic lithium salts are preferable, and LiPF₆ is more preferable.

The content of the electrolyte salt containing no sulfur element in the nonaqueous electrolyte is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, particularly preferably 0.7 mol/dm³ or more and 1.5 mol/dm³ or less. By setting the content of the electrolyte salt containing no sulfur element to the above range, the ionic conductivity of the nonaqueous electrolyte can be increased.

The shape of the energy storage device according to the present embodiment is not to be considered particularly limited, and examples thereof include cylindrical batteries, prismatic batteries, flattened batteries, coin batteries and button batteries.

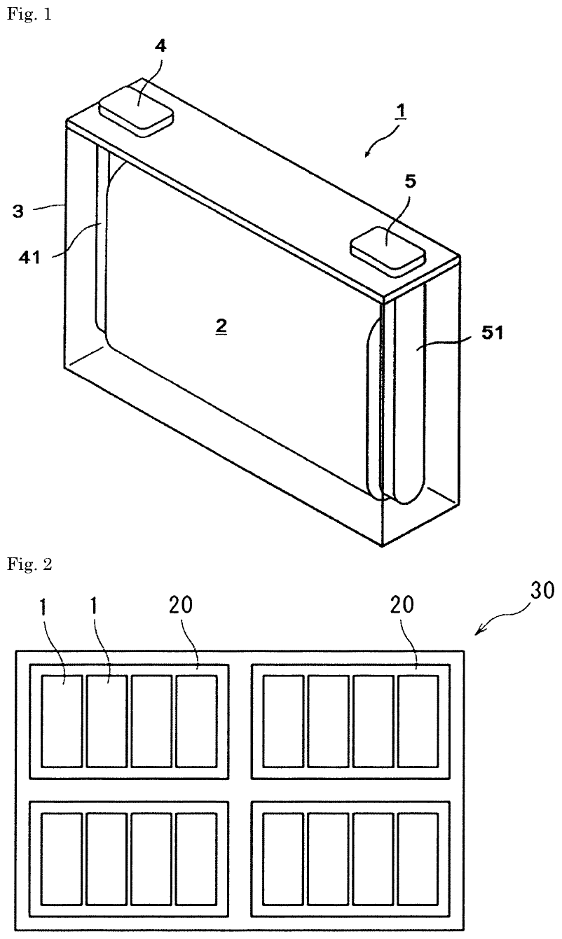

FIG. 1 illustrates an energy storage device 1 as an example of a prismatic battery. It is to be noted that FIG. 1 is a view illustrating the inside of a case in a perspective manner. An electrode assembly 2 including a positive electrode and a negative electrode wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51.

### <Configuration of Energy Storage Apparatus>

The energy storage device according to the present embodiment can be mounted as an energy storage unit (battery module) configured with a plurality of energy storage devices assembled, on power sources for automobiles such as electric vehicles (EV), hybrid vehicles (HEV), and plug-in hybrid vehicles (PHEV), power sources for electronic devices such as personal computers and communication terminals, power sources for power storage, or the like. In this case, the technique of the present invention may be applied to at least one energy storage device included in the energy storage unit.

An energy storage apparatus according to an embodiment of the present invention includes two or more energy storage devices, and includes one or more energy storage devices according to an embodiment of the present invention (hereinafter, referred to as “second embodiment”). The technique according to an embodiment of the present invention may be applied to at least one energy storage device included in the energy storage apparatus according to the second embodiment, and the energy storage apparatus may include one energy storage device according to an embodiment of the present invention and include one or more energy storage devices not according to an embodiment of the present invention, or may include two or more energy storage devices according to an embodiment of the present invention.

FIG. 2 illustrates an example of an energy storage apparatus 30 according to the second embodiment, obtained by further assembling energy storage units 20 that each have two or more electrically connected energy storage devices 1 assembled. The energy storage apparatus 30 may include a busbar (not illustrated) that electrically connects two or more energy storage devices 1, a busbar (not illustrated) that electrically connects two or more energy storage units 20, and the like. The energy storage unit 20 or the energy storage apparatus 30 may include a state monitor (not shown) that monitors the conditions of one or more energy storage devices.

### <Method for Manufacturing Energy Storage Device>

A method for manufacturing the energy storage device according to the present embodiment can be appropriately selected from known methods. The manufacturing method includes, for example, preparing an electrode assembly, preparing a nonaqueous electrolyte, and housing the electrode assembly and the nonaqueous electrolyte in a case. The preparation of the electrode assembly includes: preparing a positive electrode and a negative electrode, and forming an electrode assembly by stacking or winding the positive electrode and the negative electrode with a separator interposed therebetween.

Housing the nonaqueous electrolyte in the case can be appropriately selected from known methods. For example, in the case of using a nonaqueous electrolyte solution for the nonaqueous electrolyte, the nonaqueous electrolyte solution may be injected from an inlet formed in the case, followed by sealing the inlet.

The preparation of the negative electrode and the separator can be performed by a known method. The preparation of the positive electrode can be performed by a known method except that a polyanion compound containing the transition metal element described above and including a surface at least partially covered with carbon is used and a conductive agent is handled as described above. The preparation of the nonaqueous electrolyte can be performed by a known method except that the nonaqueous solvent, the electrolyte salt containing no sulfur element, the sulfur-based compound as the additive, and optionally other additives are used.

### OTHER EMBODIMENTS

It is to be noted that the energy storage device according to the present invention is not to be considered limited to the embodiment mentioned above, and various changes may be made without departing from the scope of the present invention. For example, to the configuration of one embodiment, the configuration of another embodiment can be added, and a part of the configuration of one embodiment can be replaced by the configuration of another embodiment or a well-known technique. Furthermore, a part of the configuration according to one embodiment can be deleted. In addition, a well-known technique can be added to the configuration according to one embodiment.

While the case where the energy storage device is used as a nonaqueous electrolyte secondary battery (for example, lithium ion secondary battery) that can be charged and discharged has been described in the embodiment mentioned above, the type, shape, size, capacity, and the like of the energy storage device are arbitrary. The present invention can also be applied to various secondary batteries, and capacitors such as electric double layer capacitors and lithium ion capacitors.

While the electrode assembly with the positive electrode and the negative electrode stacked with the separator interposed therebetween has been described in the embodiment mentioned above, the electrode assembly may include no separator. For example, the positive electrode and the negative electrode may be brought into direct contact with each other, with a non-conductive layer formed on the active material layer of the positive electrode or negative electrode.

### EXAMPLES

Hereinafter, the present invention will be described more specifically with reference to Examples. The present invention is not limited to the following Examples.

### Example 1

### (Preparation of Polyanion Compound)

While a 1 mol/dm³ aqueous FeSO₄ solution was added dropwise at a constant rate to a 2 dm³ reaction case containing 750 cm³ of ion-exchanged water, a 4 mol/dm³ aqueous NaOH solution, a 0.5 mol/dm³ aqueous NH₃ solution, and a 0.5 mol/dm³ aqueous NH₂NH₂ solution were added dropwise so that the pH during that time is maintained at a constant value of 10.0+0.1, thereby preparing an Fe(OH)₂ precursor. The temperature of the reaction case was set at 50° C.±2° C. Next, the prepared Fe(OH)₂ precursor was taken out from the reaction case, and 116 parts by mass of LiH₂PO₄ and 10 parts by mass of sucrose powder were solid-phase mixed with respect to 100 parts by mass of the Fe(OH)₂ precursor. Then, the resulting mixture was fired at a firing temperature of 650° C. under a nitrogen atmosphere to prepare a polyanion compound in which LiFePO₄ as a polyanion compound was coated with carbon.

### (Preparation of Positive Electrode)

The polyanion compound obtained above, N-methylpyrrolidone (NMP) as a dispersion medium, and PVDF as a binder were used. The polyanion compound, the binder and the dispersion medium were mixed. At that time, solid content mass ratio of the positive active material:the binder was set to 95:5, and an appropriate amount of a dispersion medium was added to the mixture to adjust the viscosity, thereby preparing a positive active material layer paste. Next, the positive active material layer paste was applied onto an aluminum foil as a positive substrate, dried at 120° C., and roll-pressed to form a positive active material layer on the positive substrate. The coating amount of the positive active material layer paste was 10 mg/cm² in terms of solid content. In this way, a positive electrode was obtained.

### (Measurement of BET Specific Surface Area)

The BET specific surface area of the positive active material layer obtained as described above was measured by the above-described measurement method to obtain a first BET specific surface area. The BET specific surface area of the polyanion compound surface-coated with carbon obtained above was measured by the measurement method described above, and then the coated carbon was removed by firing to obtain a polyanion compound. Next, the BET specific surface area of the resulting polyanion compound was measured by the measurement method described above, and the difference between the BET specific surface area of the polyanion compound surface-coated with carbon and the BET specific surface area of the polyanion compound from which carbon had been removed was determined to obtain a second BET specific surface area. Then, a ratio (%) of the second BET specific surface area of the carbon to the first BET specific surface area of the obtained positive active material layer was obtained. The results are shown in Table 1.

### (Fabrication of Negative Electrode)

Graphite was used as a negative active material, SBR was used as a binder, and CMC was used as a thickener. The negative active material, the binder, the thickener, and water as a dispersion medium were mixed together. At that time, the mass ratio of solid components, negative active material:binder:thickener was set to 97:2:1. An appropriate amount of water was added to the obtained mixture to adjust the viscosity, thereby preparing a negative composite paste. The negative composite paste was applied onto a copper foil as a negative substrate and dried to prepare a negative active material layer on the negative substrate. After that, roll pressing was performed to fabricate a negative electrode.

### (Preparation of Nonaqueous Electrolyte)

LiPF₆ as an electrolyte salt containing no sulfur element was dissolved at a concentration of 1 mol/dm³ in a mixed solvent obtained by mixing EC and EMC at a volume ratio of 3:7, and 4,4′-bis(2,2-dioxo-1,3,2-dioxathiolane) as a sulfur-based compound was dissolved at a concentration of 0.5% by mass as an additive to prepare a nonaqueous electrolyte.

### (Fabrication of Energy Storage Device)

Next, the positive electrode and the negative electrode were stacked with a separator, which was composed of a polyethylene porous membrane substrate and a heat resistant layer formed on the polyethylene porous membrane substrate, interposed therebetween to fabricate an electrode assembly. The heat resistant layer was disposed on the surface facing the positive electrode. The electrode assembly was housed into an aluminum prismatic case, and a positive electrode terminal and a negative electrode terminal were attached. The nonaqueous electrolyte was injected into the case, and then the case was sealed to obtain an energy storage device of Example 1.

### Example 2

An energy storage device of Example 2 was prepared similarly to Example 1 except that the firing temperature was 675° C. in the preparation of the polyanion compound. In Example 2, the ratio (%) of the second BET specific surface area to the first BET specific surface area was calculated similarly to Example 1. The results are shown in Table 1.

### Example 3

An energy storage device of Example 3 was prepared similarly to Example 2 except that 4-methylsulfonylethyl-2,2-dioxo-1,3,2-dioxathiolane as a sulfur-based compound was dissolved at a concentration of 0.5% by mass in place of 4,4′-bis(2,2-dioxo-1,3,2-dioxathiolane) as an additive in preparation of a nonaqueous electrolyte. In Example 3, since the same positive active material layer as that of Example 2 is used, as shown in Table 1, the ratio (%) of the second BET specific surface area to the first BET specific surface area of Example 3 is the same value as that of Example 2.

### Example 4

An energy storage device of Example 4 was prepared similarly to Example 1 except that acetylene black as a conductive agent was added to the positive active material layer paste in the preparation of the positive electrode. Specifically, the positive active material layer paste in Example 4 was prepared as follows. That is, the polyanion compound, N-methylpyrrolidone (NMP) as a dispersion medium, acetylene black as a conductive agent, and PVDF as a binder were used. The polyanion compound, the conductive agent, the binder, and the dispersion medium were mixed. At that time, the solid content mass ratio of the polyanion compound:the conductive agent:the binder was set to 90:5:5, and an appropriate amount of a dispersion medium was added to the mixture to adjust the viscosity, thereby preparing a positive active material layer paste. In Example 4, the ratio (%) of the second BET specific surface area to the first BET specific surface area was calculated similarly to Example 1. The results are shown in Table 1.

### Example 5

An energy storage device of Example 5 was prepared similarly to Example 1 except that the firing temperature was 690° C. in the preparation of the polyanion compound. In Example 5, the ratio (%) of the second BET specific surface area to the first BET specific surface area was calculated similarly to Example 1. The results are shown in Table 1.

### Example 6

An energy storage device of Example 6 was prepared similarly to Example 1 except that the firing temperature was 700° C. in the preparation of the polyanion compound. In Example 6, the ratio (%) of the second BET specific surface area to the first BET specific surface area was calculated similarly to Example 1. The results are shown in Table 1.

### Comparative Example 1

An energy storage device of Comparative Example 1 was prepared similarly to Example 1 except that the firing temperature was 630° C. in the preparation of the polyanion compound. In Comparative Example 1, the ratio (%) of the second BET specific surface area to the first BET specific surface area was calculated similarly to Example 1. The results are shown in Table 1.

### Comparative Example 2

An energy storage device of Comparative Example 2 was prepared similarly to Example 1 except that the firing temperature was 720° C. in the preparation of the polyanion compound. In Comparative Example 2, the ratio (%) of the second BET specific surface area to the first BET specific surface area was calculated similarly to Example 1. The results are shown in Table 1.

### Comparative Example 3

An energy storage device of Comparative Example 3 was prepared similarly to Example 2 except that LiPO₂F₂ was dissolved at a concentration of 1% by mass in place of 4,4′-bis(2,2-dioxo-1,3,2-dioxathiolane) as an additive in preparation of a nonaqueous electrolyte. In Comparative Example 3, since the same positive active material layer as in Example 2 is used, as shown in Table 1, the ratio (%) of the second BET specific surface area to the first BET specific surface area in Comparative Example 3 is the same value as that of Example 2.

### Comparative Example 4

An energy storage device of Comparative Example 4 was prepared similarly to Example 2 except that lithium bis(oxalate) difluorophosphate (LiFOP) was dissolved at a concentration of 1% by mass in place of 4,4′-bis(2,2-dioxo-1,3,2-dioxathiolane) as an additive in preparation of a nonaqueous electrolyte. In Comparative Example 4, since the same positive active material layer as in Example 2 is used, as shown in Table 1, the ratio (%) of the second BET specific surface area to the first BET specific surface area in Comparative Example 4 is the same value as that of Example 2.

### Comparative Example 5

An energy storage device of Comparative Example 5 was prepared similarly to Example 2 except that lithium bis(oxalate) borate (LiBOB) was dissolved at a concentration of 1% by mass in place of 4,4′-bis(2,2-dioxo-1,3,2-dioxathiolane) as an additive in preparation of a nonaqueous electrolyte. In Comparative Example 5, since the same positive active material layer as in Example 2 is used, as shown in Table 1, the ratio (%) of the second BET specific surface area to the first BET specific surface area in Comparative Example 5 is the same as that in Example 2.

### Comparative Example 6 and Comparative Example 7

Energy storage devices of Comparative Example 6 and Comparative Example 7 were prepared similarly to Example 1 except that the mixing amount of the sucrose powder was 15 parts by mass and the firing temperatures were 680° C. and 750° C., respectively, in the preparation of the polyanion compound. For Comparative Example 6 and Comparative Example 7, the ratio (%) of the second BET specific surface area to the first BET specific surface area was calculated similarly to Example 1. The results are shown in Table 1.

### [Evaluation]

### (Capacity Confirmation Test)

For each of the energy storage devices, constant current charge was performed in an environment of 25° C. to 3.6V at a charge current of 0.1 C, and then constant voltage charge was performed at 3.6 V. With regard to the charge termination conditions, charge was performed until the charge current reached 0.02 C. After charge, a pause of 10 minutes was provided, and then constant current discharge was performed in an environment of 25° C. to 2.0 V at a discharge current of 0.1 C. After the discharging, a pause time of 10 minutes was provided. The above cycle was repeated twice.

### (Test of Initial Power Performance in Low Temperature Environment)

Initial power performance in a low temperature environment was evaluated by the following procedure.

For each of the energy storage devices, constant current charge was performed in an environment of 25° C. to 3.6V at a charge current of 0.1 C, and then constant voltage charge was performed at 3.6 V. With regard to the charge termination conditions, charge was performed until the charge current reached 0.02 C. After charge, a pause time of 10 minutes was provided, and then constant current discharge was performed to 2.0 V at a discharge current of 0.1 C in an environment of 25° C. to measure the “discharge capacity at 0.1 C in an environment of 25° C.”. Next, assuming that the amount of electricity to be a half of this “discharge capacity at 0.1 C in an environment at 25° C.” was a state of charge (SOC) of 50%, and constant current charge was performed at a charge current of 0.1 C from a completely discharged state to an amount of electricity in an SOC of 50% in an environment of 25° C. After that, the device was stored in an environment of −10° C. for 3 hours, and then discharged at a discharge current of 0.1 C for 30 seconds, and a pause time of 10 minutes was provided, and then auxiliary charge was performed at a charge current of 0.1 C for 30 seconds until the SOC reached 50%. Similarly, the discharge current was adjusted to 0.3 C and 0.5 C, discharge was performed at each of the discharge currents for 30 seconds, a pause time of 10 minutes was provided, and then auxiliary charge was performed at a charge current of 0.1 C until SOC 50% was achieved. V-I characteristics were drawn from the current in each discharge and the voltage at 10 seconds after the start of discharge. In the V-I characteristics, after linear approximation was performed by the least squares method, the maximum power current value corresponding to the end-of-discharge voltage was calculated, and the maximum power current value and the end-of-discharge voltage were further multiplied to calculate “an initial power in a low-temperature environment (−10° C.) (indicated as” initial power (−10° C.) “in Table 1). The end-of-discharge voltage was set to 2.0 V. Table 1 shows the test results of initial power performance in a low temperature environment (−10° C.).

(Power Retention Rate after Storage in High Temperature Environment)
(1) The energy storage devices of Example 2 and Example 4 were subjected to a power performance test at SOC 15% according to the following procedure. Constant current charge was performed to 3.6 V at a charge current of 0.1 C in an environment of 25° C., and then constant voltage charge was performed at 3.6 V. With regard to the charge termination conditions, charge was performed until the charge current reached 0.02 C. After charge, a pause time of 10 minutes was provided, and then constant current discharge was performed to 2.0 V at a discharge current of 0.1 C in an environment of 25° C. to measure the “discharge capacity at 0.1 C in an environment of 25° C.”. Next, the amount of electricity corresponding to 15/100 of this “discharge capacity at 0.1 C in an environment of 25° C.” was set as “initial SOC 15%”. Next, constant current charge was performed from the completely discharged state until the amount of electricity reached an initial SOC of 15% at a charge current of 0.1 C. After that, the device was discharged at a discharge current of 0.1 C for 30 seconds, a pause time of 10 minutes was provided, and then auxiliary charge was performed at a charge current of 0.1 C for 30 seconds until the SOC reached 15%. Similarly, the discharge and auxiliary charge were performed in the same manner except that the discharge current was changed to 0.3 C and 0.5 C and the auxiliary charge time was set to the time at which SOC reached 15%. V-I characteristics were drawn from the current in each discharge and the voltage at 10 seconds after the start of discharge. In the V-I characteristics, linear approximation was performed using the least squares method, then the maximum power current value corresponding to the end-of-discharge voltage was calculated, and further the maximum power current value and the end-of-discharge voltage were multiplied, thereby determining the “power at initial SOC 15%”. The end-of-discharge voltage was set to 2.0 V.
(2) Next, for the energy storage devices of Example 2 and Example 4, constant current charge was performed at a charge current of 0.1 C up to 3.6 V in an environment of 25° C., and then constant voltage charge was performed at 3.6 V. With regard to the charge termination conditions, charge was performed until the charge current reached 0.02 C. The energy storage devices were thus charge charged to SOC 100%, and then stored in a thermostatic chamber at 85° C. for 10 days. After a lapse of 10 days, the energy storage devices of Example 2 and Example 4 were stored in an environment of 25° C. for 3 hours, and then constant current discharge was performed to 2.0 V at a discharge current of 0.1 C. After that, the energy storage devices were subjected to constant current charge at a charge current of 0.1 C up to 3.6 V, and then subjected to constant voltage charge at 3.6 V. With regard to the charge termination conditions, charge was performed until the charge current reached 0.02 C. After a ten minute pause was provided after charge, and then constant current discharge was performed at a discharge current of 0.1 C up to 2.0 V under a 25° C. environment, and the “0.1 C discharge capacity in an environment of 25° C. after storage in a high temperature environment” was measured. Next, assuming that the amount of electricity to be 15/100 of the “0.1 C discharge capacity in an environment of 25° C. after storage in a high temperature environment” was set as “SOC 15% after storage in a high temperature environment”, and constant current charge was performed at a charge current of 0.1 C to an amount of electricity in an SOC of 15% after storage in a high temperature environment. After that, the V-I characteristics were drawn by the same method as in the above (1), and the “power at SOC 15% after storage in a high temperature environment” was determined.
(3) The power retention rate after storage in a high temperature environment (referred to as “power retention rate after storage at high temperature” in Table 2) was calculated by dividing the power at SOC 15% after storage in the high temperature environment by the power at initial SOC 15% and multiplying the result by 100. The results are shown in Table 2.

TABLE 1

| | Positive active | | | |
|---|---|---|---|---|
| | material | | Positive active | |
| | Ratio of second BET | | material layer | |
| | specific surface area | | Content of | Evaluation |
| | to first BET specific | | conductive | Initial power |
| | surface area | Nonaqueous electrolyte | agent | (−10° C.) |
| | [%] | Additive | [% by mass] | [W] |
| Comparative | 10 | 4,4′-Bis(2,2-dioxo-1,3,2-dioxathiolane) | 0 | 3.1 |
| Example 1 | | | | |
| Example 1 | 15 | 4,4′-Bis(2,2-dioxo-1,3,2-dioxathiolane) | 0 | 4.4 |
| Example 2 | 20 | 4,4′-Bis(2,2-dioxo-1,3,2-dioxathiolane) | 0 | 4.5 |
| Example 3 | 20 | 4-Methylsulfonylethyl-2,2-dioxo-1,3,2- | 0 | 4.5 |
| | | dioxathiolane | | |
| Example 4 | 20 | 4,4′-Bis(2,2-dioxo-1,3,2-dioxathiolane) | 5 | 4.7 |
| Example 5 | 25 | 4,4′-Bis(2,2-dioxo-1,3,2-dioxathiolane) | 0 | 4.6 |
| Example 6 | 30 | 4,4′-Bis(2,2-dioxo-1,3,2-dioxathiolane) | 0 | 4.8 |
| Comparative | 35 | 4,4′-Bis(2,2-dioxo-1,3,2-dioxathiolane) | 0 | 3.3 |
| Example 2 | | | | |
| Comparative | 20 | LiPO₂F₂ | 0 | 3.2 |
| Example 3 | | | | |
| Comparative | 20 | Lithium bis(oxalate)difluorophosphate | 0 | 3.0 |
| Example 4 | | | | |
| Comparative | 20 | Lithium bis(oxalate)borate | 0 | 3.0 |
| Example 5 | | | | |
| Comparative | 10 | 4,4′-Bis(2,2-dioxo-1,3,2-dioxathiolane) | 0 | 3.2 |
| Example 6 | | | | |
| Comparative | 35 | 4,4′-Bis(2,2-dioxo-1,3,2-dioxathiolane) | 0 | 3.4 |
| Example 7 | | | | |

TABLE 2

| | Positive active | | | |
|---|---|---|---|---|
| | material | | Positive active | Evaluation |
| | Ratio of second BET | | material layer | Power retention |
| | specific surface area | | Content of | rate after high |
| | to first BET specific | | conductive | temperature |
| | surface area | Nonaqueous electrolyte | agent | storage |
| | [%] | Additive | [% by mass] | [%] |
| Example 2 | 20 | 4,4′-Bis(2,2-dioxo-1,3,2-dioxathiolane) | 0 | 90 |
| Example 4 | 20 | 4,4′-Bis(2,2-dioxo-1,3,2-dioxathiolane) | 5 | 85 |

As shown in Table 1 above, in Examples 1 to 6 in which the ratio of the second BET specific surface area to the first BET specific surface area was more than 10% and less than 35%, and the nonaqueous electrolyte contained a sulfur-based compound, the initial power in a low temperature environment was high. On the other hand, in Comparative Example 1, Comparative Example 2, Comparative Example 6 and Comparative Example 7 in which the ratio of the second BET specific surface area to the first BET specific surface area was 10% or less or 35% or more, and Comparative Examples 3 to 5 in which the nonaqueous electrolyte did not contain a sulfur-based compound, the initial power in a low temperature environment was lower than that in Examples 1 to 6.

Further, as shown in Table 2 above, comparing Example 2 and Example 4 in which the ratio of the second BET specific surface area to the first BET specific surface area and the sulfur-based compound were the same, in Example 2 in which the positive active material layer did not contain a conductive agent, the power retention rate after storage in a high temperature environment was higher than that in Example 4 in which the positive active material layer contained a conductive agent. In Examples 2 and 4, the power retention rate after storage in a high temperature environment at a relatively low SOC is shown, but it is considered that a similar effect can be obtained even at a relatively high SOC.

As a result, it was shown that the energy storage device has high initial power in a low temperature environment.

### DESCRIPTION OF REFERENCE SIGNS

1: Energy storage device
2: Electrode assembly
3: Case
4: Positive electrode terminal
41: Positive electrode lead
5: Negative electrode terminal
51: Negative electrode lead
20: Energy storage unit
30: Energy storage apparatus

1. An energy storage device comprising:
a positive electrode including a positive active material layer containing a positive active material; and
a nonaqueous electrolyte, wherein
the positive active material contains a polyanion compound containing a transition metal element and including a surface at least partially covered with carbon,
a ratio of a second BET specific surface area which is a BET specific surface area of the carbon to a first BET specific surface area which is a BET specific surface area of the positive active material layer is more than 10% and less than 35%, and
the nonaqueous electrolyte contains an electrolyte salt containing no sulfur element and a sulfur-based compound.

2. The energy storage device according to claim 1, wherein the positive active material layer does not substantially contain a conductive agent.

3. An energy storage apparatus comprising two or more energy storage devices, and comprising one or more energy storage devices according to claim 1.
